(19) United States
(12) Patent Application Publication
(10) Pub. No.: US 2010/0149552 A1
(43) Pub. Date: Jun. 17, 2010

(54) OPTICAL METROLOGY SYSTEM

(75) Inventors: Patrick Juncar, Etiolles (FR); Darine Haddad, Gaithersburg, MD (US); Gerard Geneves, Chartres (FR)

Correspondence Address: EDWARDS ANGELL PALMER & DODGE LLP, P.O. BOX 55874, BOSTON, MA, 02205, US

(73) Assignees: LABORATOIRE NATIONAL DE METROLOGIE ET D'ESSAIS, Paris (FR); CONSERVATOIRE NATIONAL DES ARTS ET METIERS, Paris (FR)

(21) Appl. No.: 12/530,258

(22) PCT Filed: Feb. 5, 2008
(86) PCT No.: PCT/FR2008/050178

§ 371 Date: Jan. 27, 2010

(30) Foreign Application Priority Data
Mar. 9, 2007 (FR) 0753748

(51) Int. Cl. G01B 11/02

(52) U.S. Cl. 356/614

(57) ABSTRACT

Device for positioning an object with respect to a reference position, characterized in that it comprises a laser (1), associated with an acousto-optical modulator (3) for emitting at least two parallel laser beams modulated in phase opposition, said beams being focused on a slot (F) integral with the object (OBJ) to be positioned, the large side of said slot (F) being perpendicular to the direction of positioning, and a photodiode (13) suitable for collecting the beams emanating from the slot (F) and associated with a synchronous-detection amplifier (9) for delivering a signal expressing the position of the slot (F) with respect to the reference position.

The present invention relates to metrology systems and more particularly to optical metrology systems.

The positioning of massive objects with high precision generally requires a bulky or environment-sensitive positioning system. Certain applications may not allow such constraints, especially in the field of space where the weight and volume constraints have direct repercussions on costs, for example the costs of placing a satellite in orbit.

Among existing optical positioning devices may be cited fiber optic displacement devices, capacitive sensors or interferometric sensors.

Fiber optic displacement sensors use a set of optical fibers to emit a light beam which reflects off an object or off a part of the object to be located. Other optical fibers make it possible to guide the light reflected or scattered towards a photoelectric cell which emits a measurement signal. The positioning of the object is determined according to its nature and the quantity of light received by the photoelectric cell with respect to the quantity of light emitted.

Capacitive sensors are based on capacitive coupling between the object to be positioned and a reference plate. The intensity of the coupling makes it possible to determine the distance between the plate and the object.

Optical rules are not very suitable for precision applications requiring compactness, sensitivity and lightness of the displacement-sensitive element.

Interferometric sensors have very good sensitivity but are suitable only for the identification of relative displacements.

In view of the foregoing, the aim of the invention is to provide a metrology system which makes it possible to obtain sub-nanometric precision achieved only by interferometric systems, in a compact arrangement and therefore a system combining precision, compactness and low cost.

The subject of the invention is therefore an optical positioning device comprising a laser, associated with an acousto-optical modulator for emitting at least two parallel laser beams modulated in phase opposition, said beams being focused on a slot integral with the object to be positioned and perpendicular to the direction of positioning, and a photodiode suitable for collecting the beams emanating from the slot and associated with a synchronous-detection amplifier for delivering a signal expressing the position of the slot with respect to the reference position.

The positioning device can furthermore comprise an optical system able to collimate, focus and collect the laser beams.

The positioning device can also comprise an electrical function generator and an oscillator, the oscillator emitting at its output a radiofrequency signal exhibiting a frequency modulation by a periodic electrical signal of lower frequency, especially by a signal of rectangular form, emitted by the electrical function generator, the radiofrequency periodic signal being dispatched to the acousto-optical modulator so as to control the splitting of the laser beams.

In a positioning device such as defined above, the electrical signal delivered by the electrical function generator can be a reference signal for the synchronous-detection amplifier.

The subject of the invention is also, according to another aspect, a method for positioning an object with respect to a reference position in which the variation in position of the object with respect to the reference is detected as a function of the intensity variation of two laser beams modulated in phase opposition emerging from a slot integral with the object to be positioned.

It is possible to adjust the sensitivity of the device by modifying the width of the material slot.

It is further possible to detect the intensity variation of the laser beams emerging from the slot by virtue of a photodiode.

It is possible to obtain a position signal by synchronous detection on the basis of the signal originating from the photodiode collecting the emerging laser beams.

It is possible to obtain an error signal in parallel with a position signal after the synchronous detection.

Other aims, characteristics and advantages of the invention will become apparent on reading the following description, given solely by way of nonlimiting example and with reference to the appended drawings in which:

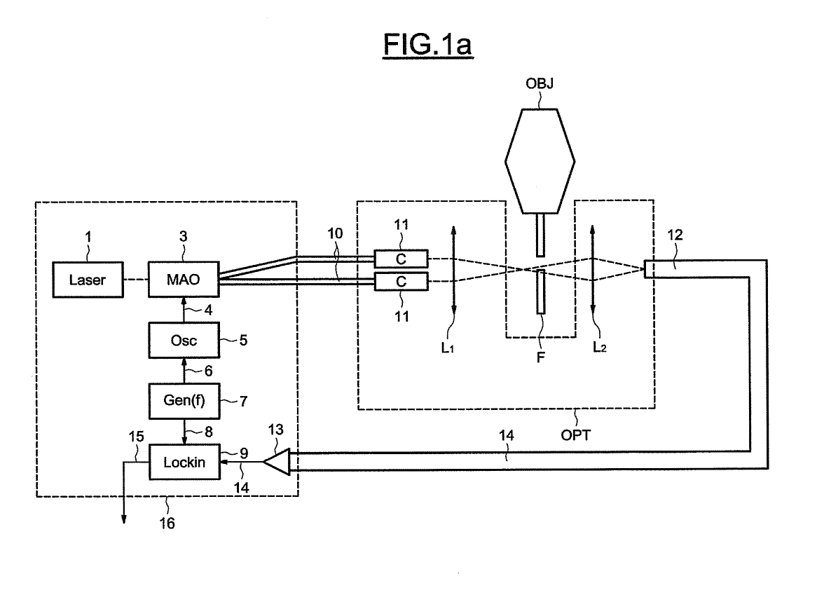

FIG. 1a describes an embodiment of the optical positioning device according to the invention;

FIG. 1b describes another embodiment of the optical positioning device according to the invention;

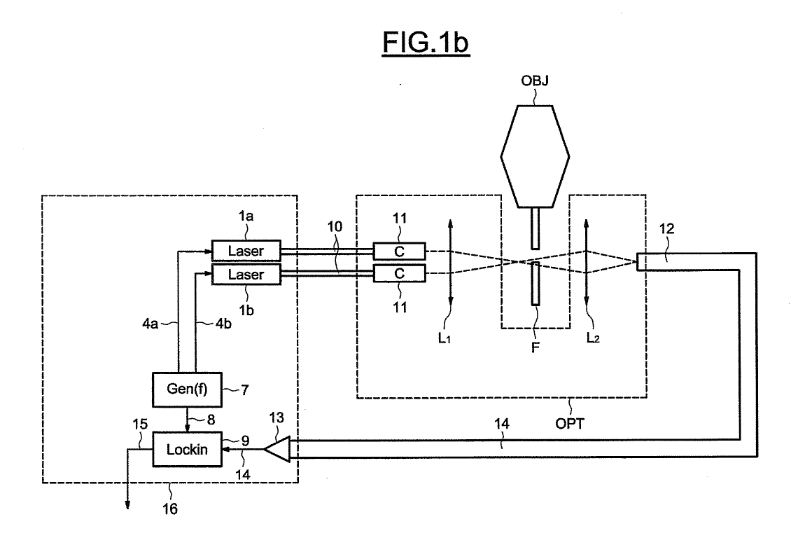

FIG. 2 schematically describes the positioning of the laser beams and of the slot;

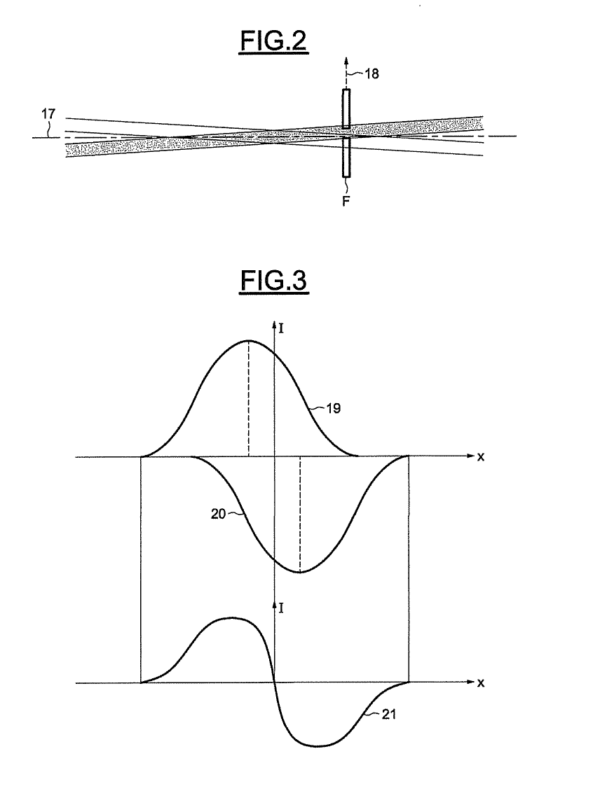

FIG. 3 describes spatial distributions of intensity obtained by means of the optical positioning device, before and after the slot.

Referring first of all to FIG. 1a, the metrology device essentially comprises a laser 1 whose beam enters an acousto-optical modulator 3 and also comprises a periodic function generator 7 connected to a synchronous-detection amplifier 9 by a connection 8 and a radiofrequency oscillator 5 which communicates with the periodic function generator 7 through the connection 6 and with the acousto-optical modulator 3 through the connection 4.

The acousto-optical modulator 3 is linked by at least two of its outputs to two single-mode fibers 10, themselves linked to collimators 11. The collimators 11 are positioned in an optical system comprising a lens L1 followed by a lens L2 and by a multi-mode fiber 12. The output of the multi-mode fiber 12 is linked to a photodiode 13 itself linked to the synchronous-detection amplifier 9 by the connection 14.

A slot F, integral with the object OBJ to be positioned, is placed between the lenses L1 and L2.

The general structure of a positioning device according to the invention has been represented in FIG. 1a. It is intended for positioning an object OBJ with respect to the optical part OPT of the optical positioning device.

The laser 1 is configured so as to emit a wave of Gaussian type exhibiting an electromagnetic transverse mode of type (0;0). FIG. 3 shows the intensity profile 19 of such a wave in the direction x.

The acousto-optical modulator 3 is based on the principle of Bragg diffraction. A sound wave is generated in a crystal by a radiofrequency wave, thereby generating a deformation of the crystal revealing a structure of lattice type. When a laser beam crosses the crystal, diffraction occurs splitting the laser beam into two beams. The distribution of the total intensity between the two beams then depends on the angle between the incident beam and the sound wave in the crystal, in accordance with the Bragg equations.

Moreover, the sound wave of the acousto-optical modulator 3 is modulated by a low-frequency signal emanating from the low-frequency generator 7. For an initial beam exhibiting a given angle of incidence, the distribution of the intensity between the two beams will be modulated by the energy modulation of the sound wave, therefore according to the power of the radiofrequency wave injected into the acousto-optical modulator. The two beams emerging from the acousto-optical modulator 3 are then in phase opposition.

FIG. 1b shows another embodiment of the invention. The acousto-optical modulator 3 has been dispensed with in favor of two lasers 1a and 1b. The laser 1a is linked by the link 4a to the low-frequency generator 7. Likewise, the laser 1b is linked by the link 4b to the low-frequency generator 7. At output, they are linked to the single-mode optical fibers 10.

The two lasers 1a and 1b are controlled by the low-frequency generator 7 in such a way as to emit alternately. Two beams modulated in phase opposition are obtained. The remainder of the device is identical to the device described in FIG. 1a.

Each of these two beams is guided by a single-mode optical fiber 10 followed by a collimator 11. The collimators 11 make it possible to align the beams relative to one another, with respect to the optical axis formed by the lenses L1 and L2 and with respect to the slot F. The beams are then focused by the lens L1 upstream of the slot F. The emerging beams converge through the lens L2 towards the input of the multi-mode optical fiber 12 which comes out on the photodiode 13. The photodiode 13 emits an electrical signal towards the synchronous-detection amplifier 9.

The synchronous-detection amplifier 9 receives on its reference input the low-frequency signal originating from the low-frequency generator 7 which has served to modulate the incident wave on the acousto-optical modulator 3. The synchronous-detection amplifier 9 isolates the signals exhibiting the same frequency as the low-frequency signal from among all the signals originating from the photodiode 13. The isolated signals are then emitted by the link 15.

A Gaussian wave exhibits the intensity distribution 19 of FIG. 3, i.e. a distribution of Gaussian type passing through a maximum and tending to a minimum in both directions of the abscissa axis. Because of the form of the curve of intensity as a function of position, a given intensity can correspond to two positions. It is not possible to determine the absolute position of the object.

By using two Gaussian beams in phase opposition, the intensity distribution 21 of FIG. 3 is obtained on output from the slot F.

The slot F is displaced in the plane formed by the two beams along the axis 18, the slot F being perpendicular to said plane. The small side of the slot is in the direction of the displacement 18 and the large side is perpendicular to the direction of displacement 18.

Several positions are possible for the slot F. The extreme positions are the positions where the overlap between the beams is zero. A prohibited position exists at the point of convergence of the beams, where the intensity profile on output from the slot F does not make it possible to determine the position of the slot F.

The slot F is of dimension equivalent to the width of the focusing spot of a laser beam, whose dimensions are equal to or greater than the square of the wavelength of the laser beam. As the slot F is displaced, it successively occults one laser beam and then the other. The two laser beams being in phase opposition and shifted spatially at the level of the slot, it is possible to determine the contribution of each laser beam to the total intensity on output from the slot. It can be shown that the intensity profile on output from the slot as a function of position describes a curve of Gaussian form vanishing at the origin of the abscissae and exhibiting a minimum and a maximum on either side of the origin.

By virtue of this intensity profile 21 and for a slot F centered on the axis 17 between the two beams, a short displacement of the slot F in the direction 18 will generate a large intensity variation. The sensitivity of the device then depends only on the slope at the origin of the intensity distribution, this slope being adjustable by modifying the focusing of the beams and/or the width of the slot.

The optical wave-based positioning device makes it possible to position, with respect to the optical part OPT of the device and with precision, an object integral with a slot F whose small width corresponds to the direction of positioning. Generally, the mass of the slot F may be considered to be negligible compared with the mass of the object OBJ. Consequently, the speed of response of the positioning system with respect to the movements of the object OBJ is fast, rendering the positioning device also suitable for detecting position and movements of objects exhibiting fast movements, such as oscillations.

As may be seen in FIGS. 1a and 1b, the optical positioning device can be broken down into a frame 16 and an optical part OPT that are linked by optical fibers. The optical positioning device thus exhibits the feature of being able to operate with the optical part OPT operating in various media comprising especially a vacuum and liquids. The optical part OPT being linked by optical fibers, its location is limited only by the absorption of said optical fibers due to the length of said optical fibers. It is thus possible to imagine applications in hostile media, for example for measuring elements or cracks in the core of a nuclear power station. The optical part OPT not exhibiting any electrical or electronic system, it does not exhibit any sensitivity to electromagnetic waves, allowing it to operate in difficult environments, such as electrical power stations, radar radomes or explosive atmospheres.

The optical positioning device could also find an application in ultrasensitive seismology, by virtue of its high sensitivity, or in applications of metrology in microscopy, such as near-field microscopy.

It is conceivable to integrate the various elements of the device by microelectronics techniques, using for example lasers of VECSEL type and waveguides to replace the optical fibers. Likewise, a large part or indeed the entirety of the control electronics can be integrated, thus making it possible to obtain a high-precision compact positioning device.

It is also conceivable to produce a device comprising a larger number of laser beams. For example four laser beams could make it possible to check the displacement of an object in two distinct directions. In this case, the slot would be replaced with a hole, each pair of beams making it possible to determine the displacement of the hole in a direction up to the limit of the diameter of said hole.

Finally, with a view to reducing costs, the optical fibers could be dispensed with. The laser beams would be directly collimated at the output of the acousto-optical modulator and the photodiode placed directly at the output of the optical system. This approach could also be combined with the use of two lasers instead of the acousto-optical modulator as described in the alternative embodiment so as to reduce costs still more drastically.

1. A device for positioning an object with respect to a reference position, characterized by the fact that it comprises a laser (1), associated with an acousto-optical modulator (3) for emitting at least two parallel laser beams modulated in phase opposition, said beams being focused on a slot (F) integral with the object (OBJ) to be positioned, the large side of said slot (F) being perpendicular to the direction of positioning, and a photodiode (13) suitable for collecting the beams emanating from the slot (F) and associated with a synchronous-detection amplifier (9) for delivering a signal expressing the position of the slot (F) with respect to the reference position.

2. The positioning device as claimed in claim 1 comprising an optical system able to collimate, focus and collect the laser beams.

3. The positioning device as claimed in claim 1 comprising an electrical function generator (7) and an oscillator (5), the oscillator (5) emitting at its output a radiofrequency signal exhibiting a frequency modulation comparable with the frequency of the periodic electrical signal emitted by the electrical function generator (7), the radiofrequency periodic signal being dispatched to the acousto-optical modulator (3) so as to control the splitting of the laser beams.

4. The positioning device as claimed in claim 3 in which the electrical signal delivered by the electrical function generator (7) is a reference signal for the synchronous-detection amplifier (9).

5. A method for positioning an object with respect to a reference position in which a variation in position of an object (OBJ) with respect to a reference position is detected as a function of an intensity variation of two laser beams modulated in phase opposition emerging from a slot integral with the object (OBJ) to be positioned.

6. The positioning method as claimed in claim 5 in which the sensitivity of the device is adjusted by modifying the width of the slot (F).

7. The positioning method as claimed in claim 5 in which the intensity variation of the laser beams emerging from the slot (F) is detected by means of a photodiode (13).

8. The positioning method as claimed in claim 7 in which a position signal is obtained by synchronous detection on the basis of the signal originating from the photodiode (13) collecting the emerging laser beams.

9. The positioning method as claimed in claim 8 in which there is obtained an error signal in parallel with a position signal after the synchronous detection.
